(19) United States
(12) Patent Application Publication
(10) Pub. No.: US 2010/0109388 A1
(43) Pub. Date: May 6, 2010

(54) VEHICLE SEAT

(76) Inventors: Klaus-Dieter Habedank, Stadthagen (DE); Mareike Krahn-Lau, Hannover (DE)

Correspondence Address: ROBERT W. BECKER & ASSOCIATES, 707 HIGHWAY 333, SUITE B, TIJERAS, NM, 87059-7507, US

(21) Appl. No.: 12/593,450

(22) PCT Filed: Feb. 22, 2008
(86) PCT No.: PCT/DE08/00319

§ 371 Date: Oct. 14, 2009

(30) Foreign Application Priority Data
Mar. 26, 2007 (DE) 10 2007 0140370.4

(51) Int. Cl. B60N 2/32; B60N 2/44; B60N 2/48

(52) U.S. Cl. 297/119; 297/463.1; 297/378.1; 297/341

(57) ABSTRACT

A support for a support material that is to be embroidered, comprising a strip-shaped support that in a conveying direction thereof and/or transversely to the conveying direction is provided with a plurality of window-like openings for passage of an embroidery needle, wherein the window-like openings are adapted to be covered by the support material. A conveying device is provided and has a drive mechanism for displacing the strip-shaped support. An embroidery machine or sewing machine incorporating the conveying device is also provided.

The present invention relates to a vehicle seat pursuant to the introductory portion of claim 1.

Vehicle seats having various actuator-operated adjustments are known. Thus, for example, the backrest, after being released, can be actuator-operated out of a locked, upright position of use into a functional position. Furthermore known are electrical longitudinal adjustments of the seat frame relative to the chassis, electrical seat cushion adjustments, lordosis adjustments and head support adjustments. In addition to the position of use, certain functional positions, in particular for safety reasons, can also be locked in position, so that for the adjustment first the locking has to be released. This is generally effected by manual actuation of a release mechanism. After the release, the actuator-operated adjustment is effected by actuating a further control element, e.g. a switch. Electric motors are generally used as actuators. In this connection, systems having two electric motors are also known, whereby the first electric motor effects the release, and subsequently the second electric motor effects the adjustment. The capital expenditure necessary for this is, however, relatively high, and thus expensive. In addition, considerable installation space is required for the installation of various adjustments.

An apparatus for locking a foldable backrest of a vehicle seat is known from DE 102 11 400 B4. The electrical locking operates via a detent and a bolt. In addition, a blocking mechanism is provided.

U.S. Pat. No. 7,118,178 B2 shows a foldable vehicle seat according to which an electrical folding forward is effected by means of a planetary gear system. No locking of the position of use is provided.

DE 195 41 221 C2 discloses an apparatus for facilitating access to the rear seats of a two-door motor vehicle, according to which after a manual release an electric motor operated adjustment is effected.

The object of the present invention is to embody a vehicle seat of the aforementioned general type in such a way that in the folded-forward position of the backrest (cargo-position), an additional locking is accomplished.

This object is realized by the features of claim 1. Advantageous and expedient further developments of the realization of the object are provided in the dependent claims.

With a vehicle seat having a plurality of seat parts and a locking device for locking at least one adjustable seat part, the invention proposes embodying and arranging an actuator for the adjustment of the at least one seat part in such a way that by means of successive partial movements of the actuator, the adjustable seat part can be unlocked from a locked first position (for example starting position or basic position), can be shifted from the unlocked first position into a second position (for example functional position), and can again be locked in the second position. Depending upon the starting position, the first position can be the basic or starting position, or also the functional position, and the second position can be the functional position or the basic or starting position. The functional position can be the cargo position, the easy-entry position, the table position, the adjustment position for the seat cushions, the head supports, etc.

For this purpose, pursuant to a further development of the realization of the object, a control member that can be actuated by the actuator is provided, by means of which the locking device can be shifted between its locking position and its unlocking or release position, and vice versa.

The inventive configuration has the advantage that with only one actuator, the pertaining seat part of the vehicle seat, in particular a pivotable backrest, can, by means of successive partial movements of the actuator, be transferred or converted from the position of use into a functional position, and vice versa, whereby in the functional position in addition a locking is achieved. With a backrest, the functional position is preferably the cargo position.

The invention will be explained in greater detail subsequently with the aid of the accompanying drawing, which shows one exemplary embodiment and in which:

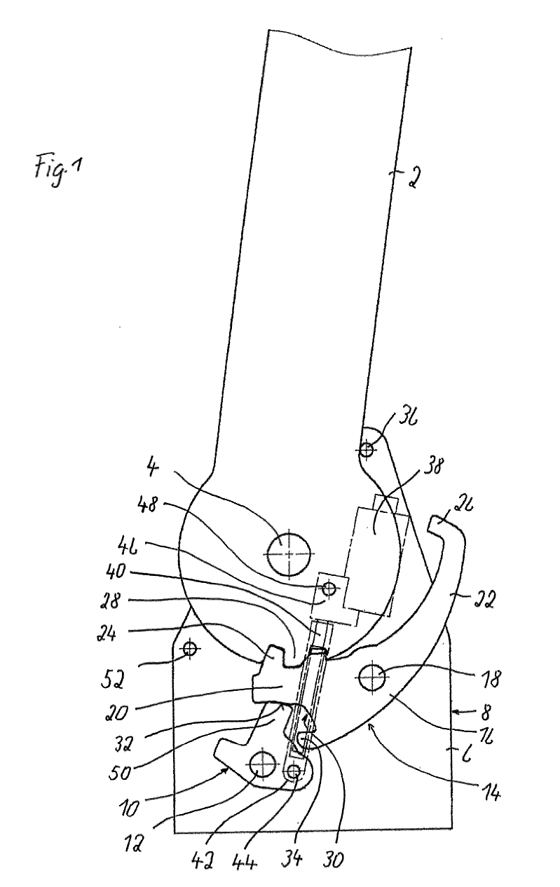

FIG. 1 is a schematic illustration of a pivotable backrest of a vehicle seat in a locked position of use,

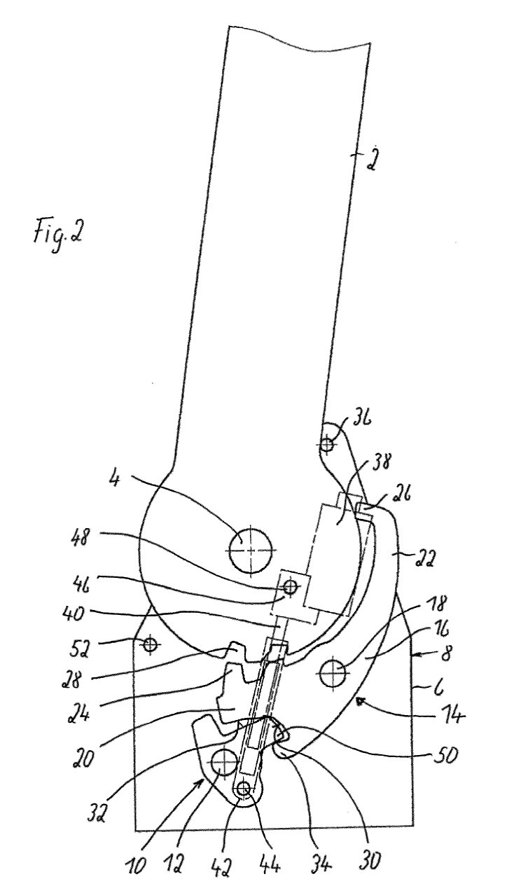

FIG. 2 shows the backrest of FIG. 1 in the unlocked state,

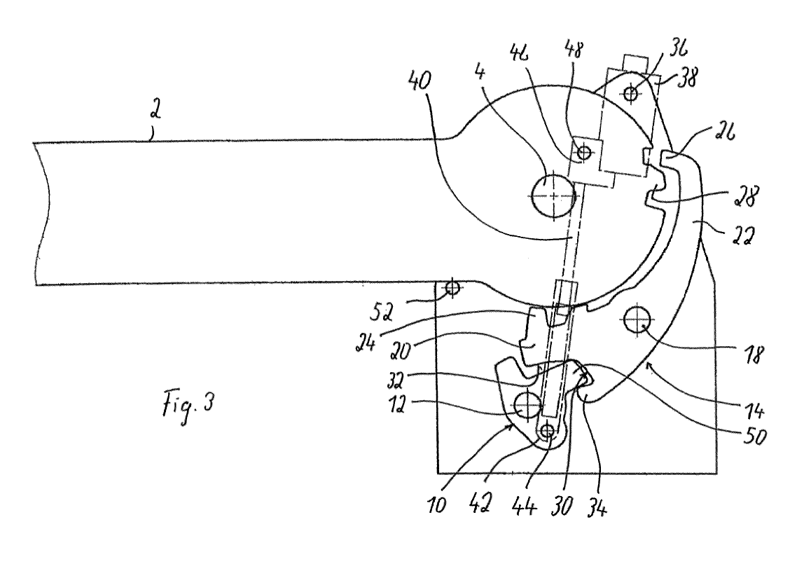

FIG. 3 shows the backrest of FIG. 1 or FIG. 2 in the unlocked folded forward state, and

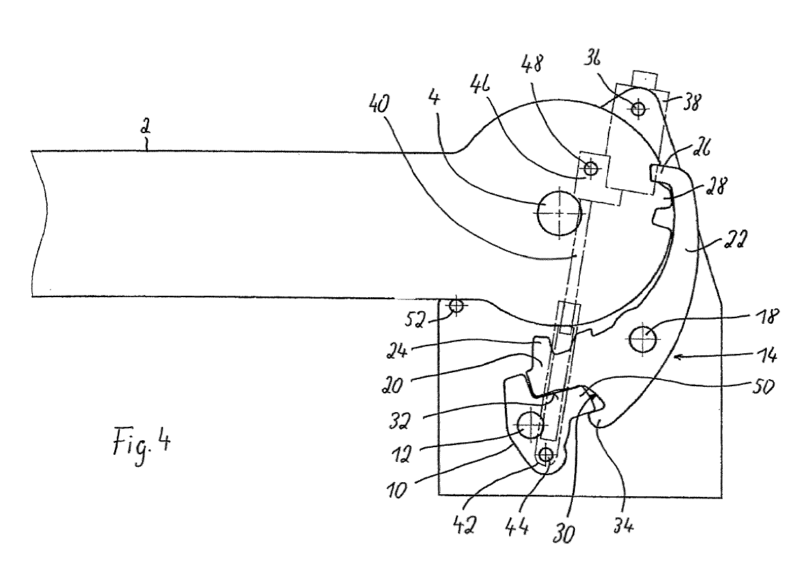

FIG. 4 shows the backrest of FIG. 3 in the locked state.

Identical components, and components that correspond to one another, are provided with the same reference numerals in the figures of the drawings.

The drawings, in a side view, schematically show parts of a vehicle seat having a backrest 2 that is disposed on a bracket 6 of a seat part 8 of the vehicle seat so as to be pivotable about an axis 4.

A control member 10 in the form of a cam is disposed on the bracket 6 so as to be rotatable about an axis 12. The cam 10 is operatively connected with a locking device for the catching or locking and the unlocking or release of the backrest 2. The locking device is comprised of a dual-arm pawl or detent 16 that is connected with the bracket 6 so as to be pivotable about an axis 18.

The detent 16 has a slightly concavely curved configuration relative to the axis 4, and is provided with a detent arm 20 that faces toward the cam and a detent arm 22 that faces away from the cam. The detent arm that faces toward the cam is provided with a tooth construction 24 that faces toward the backrest. The free end of the detent arm 22 that faces away from the cam is provided with an angled-off portion 26 that faces toward the backrest. Associated with the tooth construction 24 and the angled-off portion 26, which forms a tooth, is a tooth element 28 that is formed on the backrest.

The detent arm 20 that faces toward the cam is provided on one side with a control curve 32 that is in operative connection with the cam 10 and ends at a nose 34 that serves as an abutment for the cam.

In its position of use, the back of the backrest 2 rests against a stop 36, which limits the pivoting movement into the upright position of use.

An actuator in the form of an electric motor 38 is provided that is embodied as a spindle motor and drives a spindle 40, one end 42 of which is connected with the control member, i.e. the cam, 10 in a pivot joint 44, and the other end 46 of which is connected with the backrest 2 in a pivot joint 48. The spindle 40 adjusts the distance between the pivot joints 44 and 48.

In the locked position of use of the backrest pursuant to FIG. 1, the spindle 40 is in its maximum retracted position, i.e. with the minimum distance between the pivot joints 44 and 48. In this locked position of use, the locking of the backrest is effected by engagement of the tooth construction 24 of the detent 16 into the tooth element 28 of the backrest. In this state, a control nose 50 of the cam 10 rests against a portion of the control curve 32 that is spaced from the abutment, i.e. the nose, 34.

Pursuant to the present invention, when current flows through the electric motor 38, it functionally carries out successive partial movements. In a first partial movement, as shown in FIG. 2, by extending the spindle 40 the cam 10 is pivoted in the clockwise direction in the drawing, whereby the control nose 40 of the cam 10 slides along the control curve 32 until the control nose 50 of the cam arrives at the abutment 34 of the detent 16, so that by means of a further extension of the spindle 40, the detent 16 is pivoted in the counter clockwise direction of the drawing, as a result of which the tooth construction 24 of the detent pivots out of the tooth element 28 of the backrest 2 until the angled-off portion 26 of the detent arm 22 comes to rest against the backrest 2, as shown in FIG. 2.

From the unlocked basic position of the backrest 2 illustrated in FIG. 2, by means of a further extension of the spindle toward the top, accompanied by an increase of the distance between the pivot joints 44 and 48, the backrest can be folded toward the front into a cargo position, which is illustrated in FIGS. 3 and 4.

The forward folding movement of the backrest 2 is delimited by a stop 52 on the bracket.

In the folded forward functional position of the backrest 2 illustrated in FIG. 3, the tooth construction 24 of the detent 16 is initially out of engagement with the tooth element 28 of the backrest. By means of a further extension of the spindle 40, the control nose 50 of the control cam 10 presses against the abutment 34 of the detent 16, as a result of which the latter is pivoted in the counter clockwise direction and via its angled-off portion 26, which is formed at the free end of the detent arm 22 and forms a locking tooth, engages into the tooth element 28 of the backrest. The backrest 2 is thereby locked in the folded forward functional position (cargo position), which is illustrated in FIG. 4.

To transfer the backrest 2 out of the locked functional position of FIG. 4 into the locked basic position of FIG. 1, by actuating the actuator, i.e. the electric motor, 38, initially by retracting the spindle 40 the control curve 32 is acted upon by the control nose 50 of the cam 10, as a result of which the locking detent 16 is pivoted in the clockwise direction and the angled-off portion 26 of the detent 16 disengages or withdraws from the tooth element 28 of the backrest, so that the backrest is unlocked. By means of a further retraction of the spindle, as a result of which the distance between the two pivot joints 44 and 48 is reduced, the backrest is returned into the position of use illustrated in FIGS. 1 and 2 until the backrest 2 arrives at the stop 36. In this return phase the backrest is still unlocked. By further retraction of the spindle 40, as shown in FIG. 1, the cam 10 is pivoted in the counter clockwise direction, so that the control nose 50 of the cam 10 presses against the control curve 32 of the detent 16, and the tooth construction 24 catches or engages in the tooth element 28, as a result of which the backrest 2 is locked. With this, one movement cycle is completed.

In the event that not only the backrest, but also a further part of the vehicle seat, e.g. a seat cushion frame, is to be adjusted, the pivot connection 48, instead of being directly on the backrest 2, can be on another pivot member, so that by means of this pivot member not only the backrest but also the further seat part (seat cushion frame) can be adjusted. As a result, an adjustment of the backrest and of the seat cushion frame can, for example, be achieved simultaneously in order to achieve a cargo position with seat cushion frame adjusted toward the front and downwardly, and with folded forward backrest with horizontal upper side.

1. Vehicle seat having a plurality of seat parts (2, 6), with an actuator (38) for the adjustment of at least one seat part (2), and with a locking device (14) for the locking of the at least one adjustable seat part (2), characterized in that, by means of successive partial movements of the actuator (38), the at least one adjustable seat part (2) can be unlocked from a locked first position, can be shifted from the unlocked first position into a second position, and can be locked in the second position.

2. Vehicle seat according to claim 1, characterized in that, the first position is a basic position or starting position, or is a functioning position.

3. Vehicle seat according to claim 1, characterized in that, the second position is a functional position or is a basic position or starting position.

4. Vehicle seat according to claim 2 or 3, characterized in that, the functional position is the cargo position, easy-entry position, the table position, adjustment positions for seat cushions, head supports, lordosis, etc.

5. Vehicle seat according to claim 1, characterized in that, a control member (10) that can be actuated by the actuator (38) is provided, by means of which the locking device (14) can be shifted between its locking position and its unlocking position, and vice versa.

6. Vehicle seat according to claim 1 or 5, characterized in that, the locking device (14) includes a detent (16) that is provided with tooth sections (24, 26) that cooperate with an associated tooth section (28) of the adjustable seat part (2).

7. Vehicle seat according to claim 6, characterized in that, the detent (16) is pivotably disposed on a vehicle seat part (6) that is stationary relative to the adjustable seat part (2).

8. Vehicle seat according to claim 5, 6 or 7, characterized in that, the detent (16) can be acted upon by the control member (10).

9. Vehicle seat according to one of the claims 6 to 8, characterized in that, the detent (16) has a dual arm configuration, and on both arms (20, 22) respectively has at least one tooth (24, 26) that cooperates with the tooth section (28) of the adjustable seat part (2).

10. Vehicle seat according to one of the claims 5 to 9, characterized in that, the control member (10) is formed by a cam that via a control nose (50) is in operative connection with a control curve (32) that is formed on the detent arm (20) that faces toward the cam.

11. Vehicle seat according to one of the preceding claims, characterized in that, the actuator (38) is an electric motor that is embodied as a spindle motor and drives a spindle (40), one end (42) of which is rotatably connected with the control member or cam (10) in a pivot joint (44), and the other end (46) is rotatably connected with the adjustable seat part (2) in a pivot joint (48).

12. Vehicle seat according to claim 11, characterized in that, the electric motor (32), via the spindle (40), adjusts a distance of the two pivot joints (44) relative to one another.

13. Vehicle seat according to one of the preceding claims, characterized in that, stops (36, 52) are provided on the vehicle seat part for delimiting the adjustment movement of the adjustable seat part (2) into the starting position and the functional position.

14. Vehicle seat according to one of the preceding claims, characterized in that, the pivot movement of the cam (10) is delimited by abutment of the detent arm (22) that faces away from the cam (10) against the adjustable seat part (2) in its starting position, and by engagement of the tooth (26) provided on an end of the detent arm (22) that faces away from the cam into the tooth section (28) of the adjustable seat part 92) in its functional position.

15. Vehicle seat according to one of the preceding claims, characterized in that, the tooth section (28) of the adjustable seat part (2) is formed by a tooth element.

16. Vehicle seat according to one of the preceding claims, characterized in that, the tooth (26) on the detent arm (22) that faces away from the cam is formed by an angled-off end portion that faces the adjustable seat part (2).

17. Vehicle seat according to one of the preceding claims, characterized in that, the adjustable seat part (2) is formed by a backrest of a vehicle seat, and the vehicle seat part (6) that is stationary relative to the adjustable backrest is formed by a seat part or a bracket (6) of the vehicle seat that is secured to the seat part.

18. Vehicle seat according to one of the preceding claims, characterized in that, the starting position of the adjustable seat part (2) is the basic position or the position of use of the backrest, and the functional position of the adjustable seat part (2) is the folded forward position or cargo position of the backrest.

19. Vehicle seat according to one of the preceding claims, characterized in that, the pivot joint (48) is connected with a pivot member by means of which the backrest (2) and a seat cushion frame are adjustable such that at the same time an adjustment of the backrest and of the seat cushion frame is achieved in order to realize a cargo position with the seat cushion frame shifted toward the front and down, and with the backrest folded down so as to have a horizontal upper side.
